(19) United States
(12) Patent Application Publication
(10) Pub. No.: US 2015/0115052 A1
(43) Pub. Date: Apr. 30, 2015

(54) Apparatus and Method for a Sprinkler Management System

(71) Applicant: LEHMANN SYSTEMS LLC, Ashburn, VA (US)

(72) Inventor: Michael Lehmann, Ashburn, VA (US)

(73) Assignee: LEHMANN SYSTEMS LLC, Ashburn, VA (US)

(21) Appl. No.: 14/067,369

(22) Filed: Oct. 30, 2013

(51) Int. Cl. B05B 12/02

(52) U.S. Cl. CPC B05B 12/02
USPC 239/1; 239/69

(57) ABSTRACT

A system and corresponding method for automated sprinkle management for managing a sprinkler system in a plurality of repetitive periods is provided. For a present repetitive period where sprinkling is not to be performed, an amount of one or more meteorological-related metrics is retrieved for a previous repetitive period, and the amount is logged. For a present repetitive period where sprinkling is to be performed, the method, and implementing system, includes retrieving for an elongated period, including a multiple of the repetitive periods, one or more of these amounts and calculating a sum of these amounts for the elongated period. It also includes determining a sprinkling interval based at least in part on the sum, the sprinkling interval being a period of time that the sprinkler system is operable, and causing the sprinkler system to operate for the sprinkling interval.

### BACKGROUND OF THE INVENTION

1. Field of the Invention

The present application relates generally to lawn hydration and more particularly to automated sprinkler systems.

2. Related Art

Modern sprinkler irrigation systems are programmed to deliver water to landscapes without the need of mechanical displacement of hoses in the watering geographic areas, such as relevant zones. Water distribution can be programmed to be performed evenly as between the zones, to revitalize or maintain the health of lawns or other vegetation. Water conservation can be accomplished by running systems long enough to replenish the water that has been used by the plant material since previous watering cycles.

For years, semi-automatic systems have permitted users to set predetermined schedules for watering of the respective zones, by setting the start/stop and run times for the sprinklers feeding the respective zones. The schedules are based on reasonable estimates of how often and for how long the zones are to be run. Schedules are set for relevant efficiency, schedules are sometimes frequently updated to allow for fluctuations in length of day, temperatures and other environmental factors.

What is required is a method, and a corresponding system implementing the method, to permit fully automated and managed operation of sprinkler systems for varying zones based on such parameters as measurements of environmental factors, historical factors, future forecasts and meteorological data. What is also required for advances in the art is user-determination of applicability of such parameters for optimal operation in respective zones.

### SUMMARY OF THE INVENTION

Exemplary embodiments include a method for automated sprinkle management for managing a sprinkler system in a plurality of repetitive periods. The method includes (a) for a present repetitive period where sprinkling is not to be performed, retrieving an amount of one or more meteorological-related metrics for a previous repetitive period, and logging the amount. It also includes (b) for a present repetitive period where sprinkling is to be performed, certain steps (A) and (B) being performed. Step (A) includes retrieving for an elongated period, including a multiple of the repetitive periods, one or more of the amounts and calculating a sum of the one or more of the amounts for the elongated period. Step (B) includes determining a sprinkling interval based at least in part on the sum, the sprinkling interval including a period of time where the sprinkler system is operable, and causing the sprinkler system to operate for the sprinkling interval.

In certain exemplary embodiments, step (b) further includes: (C) comparing a first pre-established threshold value to the meteorological-related metric to determine a first comparison value; and (D) determining the sprinkling interval based at least in part on the first comparison value. In certain exemplary embodiments, step (b) further includes: (E) if the meteorological-related event is present, one or more times: retrieving a chance of continuation of the meteorological-related event within a designated time period, and comparing the chance of continuation to a second pre-established threshold value to determine a second comparison value; and (F) determining the sprinkling interval based at least in part on the second comparison value.

Also, in an exemplary embodiment, any one of steps (a) and (b) are performed for at least one geographical area. Each of steps (a) and (b) can be performed in sequential order, and the at least one geographical area can include a zone.

In certain other embodiments, the method can include any one of: (a) receiving a first sprinkling input, the first sprinkling input relating to at least one of: a frequency of sprinkling; and a period of sprinkling, and receiving a second sprinkling input, the second sprinkling input relating to an amount of sprinkling, where the determination of the sprinkling interval is based on the first sprinkling input and the second sprinkling input; and (b) determining the sprinkling interval by retrieving a predetermined default value and assigning the value as the sprinkling interval. The first sprinkling input can be retrieved from any one of: a user over a human-user interface, and a system over a communications interface. In exemplary embodiments, the frequency of sprinkling includes the identify of one or more days where sprinkling is performed per week, and the period of sprinkling includes a period of time where sprinkling is performed per each sprinkling day. In exemplary embodiments, the amount of sprinkling includes any one of: a volumetric related amount of sprinkling performed by the sprinkler system, the sprinkler system being managed by an automated sprinkle management system, and a predetermined default volumetric related amount of sprinkling.

Also, in certain exemplary embodiments, one or more indications are displayed to a user in relation to any one of steps (a) and (b), and the displaying is effected in relation to at least one of: a local display resident on an automated sprinkle management system, and a remote display remote to the automated sprinkle management system.

In yet other exemplary embodiments, the method includes at least one of: the repetitive period being a present day of a week, the previous repetitive period being a day of the week preceding the present day, the meteorological-related metric being an amount of rainfall, and the elongated period including a multiple of the repetitive periods is a week.

In addition, in certain exemplary embodiments, the meteorological-related metric of step (C) is a chance of rain, and the first pre-established threshold value is a threshold value relating to the chance of rain. In related exemplary embodiments, the method includes any one of: the meteorological-related metric of step (C) and the meteorological-related metric of step (E) being a chance of rain. In these exemplary embodiments, the first pre-established threshold value can be a threshold value relating to the chance of rain, and the second pre-established threshold value can be a threshold value relating to the chance of rain.

Furthermore, in certain exemplary embodiments, an automated sprinkle management system for managing a sprinkler system in a plurality of repetitive periods is provided. In exemplary embodiments, the system includes: a memory operable to retain a series of instructions; and a processor operable to retrieve and execute the instructions to perform a series of steps. The steps can include: (a) retrieving an amount of one or more meteorological-related metrics for a previous repetitive period, and logging the amount, if sprinkling is not to be performed for a present repetitive period; and (b) for a present repetitive period where sprinkling is to be performed, (A) retrieving for an elongated period including a multiple of the repetitive periods one or more of the amounts and calculating a sum of the one or more of the amounts for the elongated period; and (B) determining a sprinkling interval based at least in part on the sum, the sprinkling interval including a period of time where the sprinkler system is operable, and causing the sprinkler system to operate for the sprinkling interval.

In certain exemplary embodiments, step (b) further includes: (C) comparing a first pre-established threshold value to the meteorological-related metric to determine a first comparison value; and (D) determining the sprinkling interval based at least in part on the first comparison value. Also, step (b) can further include: (E) if the meteorological-related event is present, one or more times: retrieving a chance of continuation of the meteorological-related event within a designated time period, and comparing the chance of continuation to a second pre-established threshold value to determine a second comparison value; and (F) determining the sprinkling interval based at least in part on the second comparison value.

Yet in related exemplary embodiments, any one of steps (a) and (b) are performed for at least one geographical area. Also, each of steps (a) and (b) can be performed in sequential order, where the at least one geographical area includes a zone.

Also, in certain exemplary embodiments, the steps further include any one of: (c) receiving a first sprinkling input, the first sprinkling input relating to at least one of: a frequency of sprinkling; and a period of sprinkling, and receiving a second sprinkling input, the second sprinkling input relating to an amount of sprinkling, where the determining of the sprinkling interval is based on the first sprinkling input and the second sprinkling input; and (d) determining the sprinkling interval by retrieving a predetermined default value and assigning the value as the sprinkling interval. The first sprinkling input can be retrieved from any one of: a user over a human-user interface; and a system over a communications interface. The frequency of sprinkling can includes an identify of one or more days where sprinkling is performed per week, and the period of sprinkling can include a period of time where sprinkling is performed per each sprinkling day. In certain exemplary embodiments, the amount of sprinkling includes any one of: a volumetric related amount of sprinkling performed by the sprinkler system, the sprinkler system being managed by the automated sprinkle management system; and a predetermined default volumetric related amount of sprinkling.

Also, in certain exemplary embodiments, one or more indications are displayed to a user in relation to any one of steps (a) and (b); and the displaying is effected in relation to at least one of: a local display resident on the automated sprinkle management system; and a remote display remote to the automated sprinkle management system. In related embodiments, the steps include at least one of: the repetitive period being a present day of a week; the previous repetitive period being a day of the week preceding the present day; the meteorological-related metric being an amount of rainfall; and the elongated period including a multiple of the repetitive periods is a week. In related embodiments, the meteorological-related metric of step (C) is a chance of rain, and the first pre-established threshold value is a threshold value relating to the chance of rain.

In yet other related exemplary embodiment, the steps include any one of: the meteorological-related metric of step (C) and the meteorological-related metric of step (E) being a chance of rain; and any one of: the first pre-established threshold value being a threshold value relating to the chance of rain; and the second pre-established threshold value being a threshold value relating to the chance of rain.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of various exemplary embodiments including a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 is a block diagram illustrating an exemplary sprinkler management system in accordance with certain embodiments.

FIG. 2 is a block diagram illustrating an exemplary communications system of sprinkler management system in accordance with certain embodiments.

FIG. 3 is a block diagram illustrating an exemplary remote controlled sprinkler management system in accordance with certain embodiments.

FIG. 4 is a process flow chart illustrating process flows for system setup of a sprinkler management system in accordance with certain embodiments.

FIG. 5 is a process flow chart illustrating process flows for running of a sprinkler management system on a repetitive period where no sprinkling occurs.

FIG. 6 is a process flow chart illustrating process flows for running of a sprinkler management system on a repetitive period where sprinkling may occur.

### DETAILED DESCRIPTION OF VARIOUS EXEMPLARY EMBODIMENTS OF THE PRESENT INVENTION

### Exemplary Embodiments

While specific exemplary examples, environments and embodiments are discussed below, it should be understood that this is done for illustration purposes only. A person skilled in the relevant art will recognize that other components and configurations can be used without parting from the spirit and scope of the embodiments. In fact, after reading the following description, it will become apparent to a person skilled in the relevant art how to implement the invention in alternative examples, environments and embodiments.

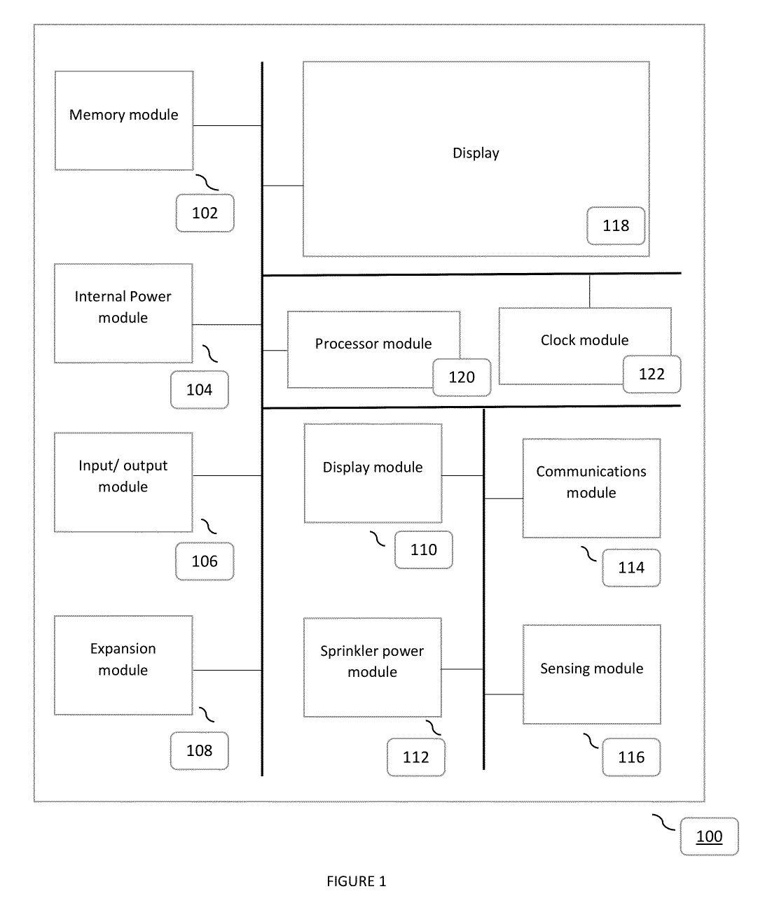

FIG. 1 is a block diagram illustrating an exemplary sprinkler management system 100 in accordance with certain embodiments. Sprinkler management system 100 includes memory module 102, power supply module 104, computer input module 106, expansion module 108, display module 110, sprinkler power module 112, communications module 114, sensing module 116, display 118, processor module 120 and clock module 122.

As described in reference to the present embodiments, modules refers to certain functional units capable of performing one or more tasks. In one or more exemplary embodiments, these modules are implemented in hardware, software, or a combination of hardware and software. For example, an exemplary module 102-118 can be implemented as a hardware circuit comprising custom VLSI circuits or gate arrays, off-the-shelf semiconductors such as logic chips, transistors, or other components. A module may also be implemented in programmable hardware devices such as field programmable gate arrays, programmable array logic, programmable logic devices or the like.

Modules may also be implemented using software, which is then stored on a storage device for execution by various types of processors. A storage device can take any form capable of storing machine-readable instructions on a digital processing apparatus. Examples of a computer readable storage medium include, but are not limited to, a semiconductor or solid state memory, magnetic tape, a removable computer diskette, a random access memory (RAM), a read only memory (ROM), a Bernoulli drive, ARDUINO, a magnetic disk, flash memory, integrated circuits, or other digital processing apparatus memory device, and an optical disk. Current examples of optical disks include a compact disk with read only memory (CD-ROM), a compact disk with read/write (CD-R/W), and a digital video disk (DVD).

In an exemplary embodiment, an identified module of executable code can comprise one or more physical or logical blocks of computer instructions which can be organized as an object, procedure, or function.

A module of executable code can be a single or a plurality of instructions, and, in a certain exemplary embodiment, can even be distributed over several different code segments, among different programs, across several storage or memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more physical devices which are referred to herein as computer readable media and/or electronic data storage devices.

In certain exemplary embodiments, processor module 120 is a processing device as defined hereinbelow. In an exemplary embodiment, processor module 120 is a central processing unit (CPU), comprising certain combinations of hardware and/or software within sprinkler management system 100 that carries out the instructions of a computer program, either resident in sprinkler management system 100 or obtained from an input to the device, by performing certain arithmetical, logical, and input/output operations. In an exemplary embodiment, processor module 120 includes an arithmetic logic unit (ALU), which performs arithmetic and logical operations, and a control unit (CU), which extracts instructions from memory and decodes and executes them, calling on the ALU when necessary. In certain exemplary embodiments, processor module 120 works in concert with the other modules of sprinkler management system 100 to permit the function of the modules.

In certain exemplary embodiments, memory module 102 is an internal (or a primary) memory, and can also include an external (or secondary) memory as defined hereinbelow. In an exemplary embodiment, memory module 102 can be directly accessible to the processor module 120. The processor module 120 reads instructions stored in the memory module 102 and executes them as required. In an exemplary embodiment, an internal (primary) memory can be a random access memory (RAM). An external (secondary) memory can include, but not limited to, a removable memory chip, a hard disk drive, a removable storage drive, representing a floppy disk drive, a magnetic tape drive, an optical disk drive, etc. In alternative embodiments, an external (secondary) memory can include other similar means for allowing computer programs or other instructions to be read by processor module 120.

In certain exemplary embodiment, internal power module 104 is a power supply module for the sprinkler management system 100. Internal power module 104 can be a battery module or a combination of a power supply module and battery module. A battery module is an electrical apparatus that provides uninterrupted and/or emergency power to the input power source. A battery module can be either rechargeable or wearable.

In certain exemplary embodiments, input/output module 106 is a communication device between a processor module 120 and another device or a user. Inputs are the signals or data received by the system, and outputs are the signals or data sent from it. Input/output module can include an input module and an output module. Input module can include an input device such as a keyboard, mouse or touchscreen. Input/output module 106 can have its own output module such as monitors and printers, or can implement an output module that sends communication to other modules, such as display module 110, communications module 114 and sprinkler power module 112 via processor module 120.

In certain exemplary embodiments, sprinkler power module 112 is a power module providing an output power and/or informational signal to a sprinkler system to either turn on or turn off sprinklers of one or more sprinkler systems (not shown). The output can direct a single sprinkler to turn on and/or off, or a plurality of sprinklers to turn on and/or off. In an exemplary embodiment, the output is in the form of a power signal, such as an alternating current (AC) signal transmitted over one or more wires. In another exemplary embodiment, the output is in the form of an analog and/or digital communications signal transmitting information. In yet another exemplary embodiment, the output is in the form of a combination of power and/or communications signals. The output can be transmitted over one or more wires and or wirelessly, in accordance with the embodiments referenced herein. In certain embodiments, one or more of the sprinklers are used to sprinkle a geographical area. In an exemplary such embodiment, a local geographical area, referred to as a zone, is sprinkled by one or more such sprinklers, based on the output.

In certain exemplary embodiments, expansion module 108 couples sprinkler management system 100 with one or more additional sprinkler management systems, such that the functions of the present sprinkler management system 100 and the one or more additional sprinkler management systems are functionally operable between one another. Here, the capabilities of the present sprinkler management system 100 can also be expanded by the same or related capabilities of the one or more additional sprinkler management systems.

In related embodiments, expansion module 108 is operable to couple sprinkler management system 100 to one or more additional modules, which can have the same or similar functionality as any of the modules of sprinkler management system 100. Here, the coupling can be effected such that the functions of the present modules of the sprinkler management system 100 and such additional module(s) are functionally operable between one another, and also, the capabilities of the modules of the present sprinkler management system 100 can also be expanded by the same or related capabilities of such additional modules. In a related such embodiment, expansion module 108 is coupled by way of function and capability expansion to one or more additional sprinkler management modules.

In exemplary embodiments and not by way of limitation, expansion module 108 provides expansion by use of shift register cascading, and providing firmware in one or more of the modules, which are modified for the expansion. In an exemplary such embodiment, expansion module 108 permits users to add a number of additional sprinkler management systems to control the operation of a plurality of geographical areas, such as zones.

In some exemplary embodiments, display module 110 transfers user inputs from display 118 to processor module 120. Display module 110 can also forward data to the display 118. The data being forwarded can include, but not limited to, graphics data for the screen displays described herein.

In certain exemplary embodiment, display 118 can include a mouse, keyboard, touch screen, microphone, joystick, stylus, light pen, or any other type of peripheral unit.

Also, in certain exemplary embodiments sprinkler power module 112 is a power supply module as defined hereinbelow. In an exemplary embodiment, power supply module converts mains Altering-Current (AC) to low-voltage regulated Direct-Current (DC) power for the internal components of sprinkler management system 100. In an exemplary embodiment, power supply module can be a standard 24V AC transformer with the current rating of at least 500 mA (12 VA).

In an exemplary embodiment, internal power module 104 can include a switching regulator to convert electrical power efficiently. In certain embodiments including a switching regulator, once sprinkler management system is connected to the power supply, the power switch will turn on and off the sprinkler management system.

Also, in certain exemplary embodiments communications module 114 allows software instructions and/or other data to be transferred between sprinkler management system 100 and external devices. The communications process/interface is explained in further hereinbelow.

In certain exemplary embodiments, sensing module 116 is sensing device for measuring various predetermined variables. Sensing module 116 can include a simple interface that requires just three wires to the sensor: ground (GND), power, and data. In exemplary embodiments, sensing module 116 is supported by one or more libraries that permit values to be read-in, and by an exemplary input/output (I/O) line over bus 124, which provides connectivity to processor module 120, any sensory related information, including for example environmental input relating to temperature and humidity, are provided to processor module 116. Exemplary variables which sensing module 116 senses include, but are not limited to, rainfall, humidity, temperature and wind speed.

In exemplary embodiments, sprinkler management system 100 enables users to use or interact with it either directly through the input/output module 106, display 118, display module 110, communication module 114 or a combination of the same.

Also, in certain exemplary embodiments, clock module 122 is an internal clock circuit allowing the sprinkler management system 100 to maintain a record of the current date and time.

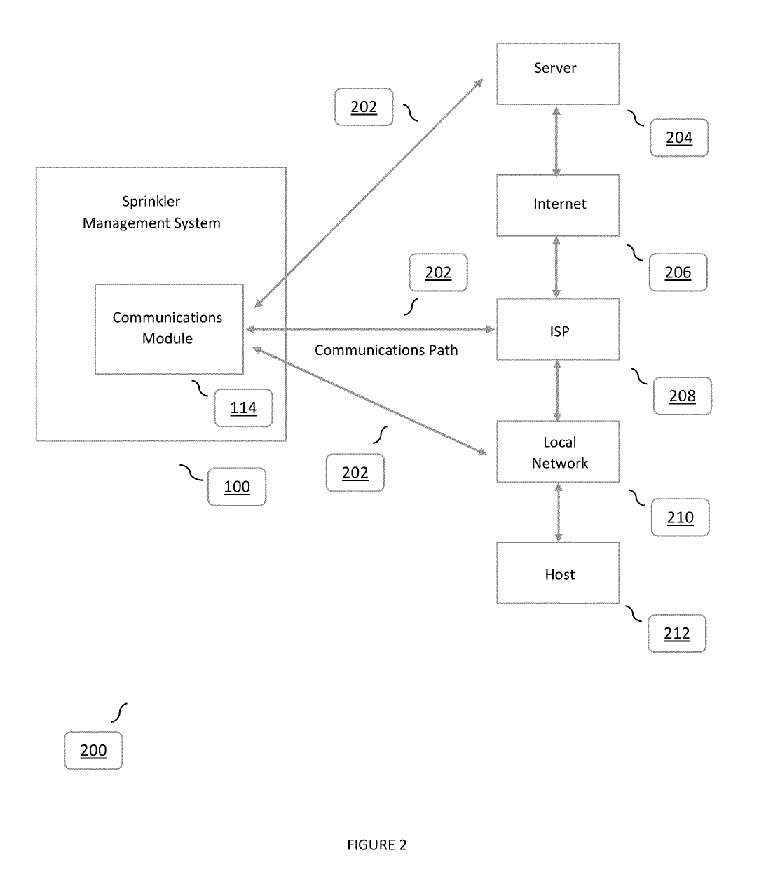

FIG. 2 is a block diagram illustrating an exemplary communications network 200 of sprinkler management system 100 in accordance with certain embodiments. One or more exemplary embodiments are practiced in the environment of the computer network or a plurality of networks comprising communications network 200. As illustrated, sprinkler management system 110 includes communications module 114 which provides coupling by way of communications paths 202 to network nodes. The network nodes include Internet Service Provider (ISP) 208, a worldwide connection of computers referenced as the Internet 206, a server 204, a local network 210 and a host 212.

Network 200 includes a private network, or a public network, or a combination of both. It also includes hardware, software, or a combination of both. In an exemplary embodiment, network 200 can be described as communication interface where a set of hardware nodes are interconnected by a communications facility, with one or more processes (hardware, software, or a combination thereof) functioning at each such node.

The processes can inter-communicate and exchange information with one another via communication pathways between them, such as interprocess communication pathways. On these pathways, appropriate communications protocols are used. Skilled persons will recognize that the distinction between hardware and software is not always easily defined, with the same or similar functions capable of being performed with use of either. This is the case for functionality associated with the communications between processes.

In certain exemplary embodiments, communications module 114 allows software and data to be transferred between sprinkler management system 100 and external devices via communications path 202. Examples of communications interfaces of network 200 that can be used with the present embodiments include, but are not limited to, a standard or cable modem, a DSL connection, a network interface (such as an Ethernet card), a communications port, a LAN connection, a WAN connection, etc. Computer programs and data transferred via the communications interface of communications network 200 are in the form of signals which can be electronic, electromagnetic, optical or other signals capable of being received by the communications interface, via communications path 202. Communications network 200, by its interface, provides a means by which sprinkler management system 100 can interface to a network such as the Internet.

In the example environment shown, communication interface 114 provides a two-way data communication coupling via a communications path 202 to a local network 210. For example, if communication module 114 includes an integrated services digital network (ISDN) card or a modem, communication module 114 provides a data communication connection to the corresponding type of telephone line, which comprises part of communications path 202. Wireless links are also possible. In any such implementation, communication module 114 sends and receives electrical, electromagnetic or optical signals which carry digital data streams representing various types of information.

Communications path 202 can provide data communication through one or more networks to other data devices. For example, in the present embodiments communications path 202 can provide a connection through local network 210 to host computer 212 or to data equipment operated by an Internet Service Provider (ISP) 208. In turn, ISP 208 provides data communication services through a worldwide packet data communication network, such as the Internet 206.

Local network 210 and Internet 206 can both use electrical, electromagnetic or optical signals that carry digital data streams. The signals through the various networks and the signals on communications path 202 and through communication interface 114, which carry the digital data to and from sprinkler management system 100, are exemplary forms of carrier waves transporting the information.

In an exemplary embodiment, sprinkler management system 100 can send or receive messages, data and/or instructions via communications module 114 and its corresponding interface through network 200 over communications path(s) 202. In an exemplary embodiment, instructions and/or data are transmitted between server 204 and communications management module 114 over Internet 206, ISP 208 and communications path 202. Exemplary application programs can be run by servers 204 functioning as application servers and/or database servers.

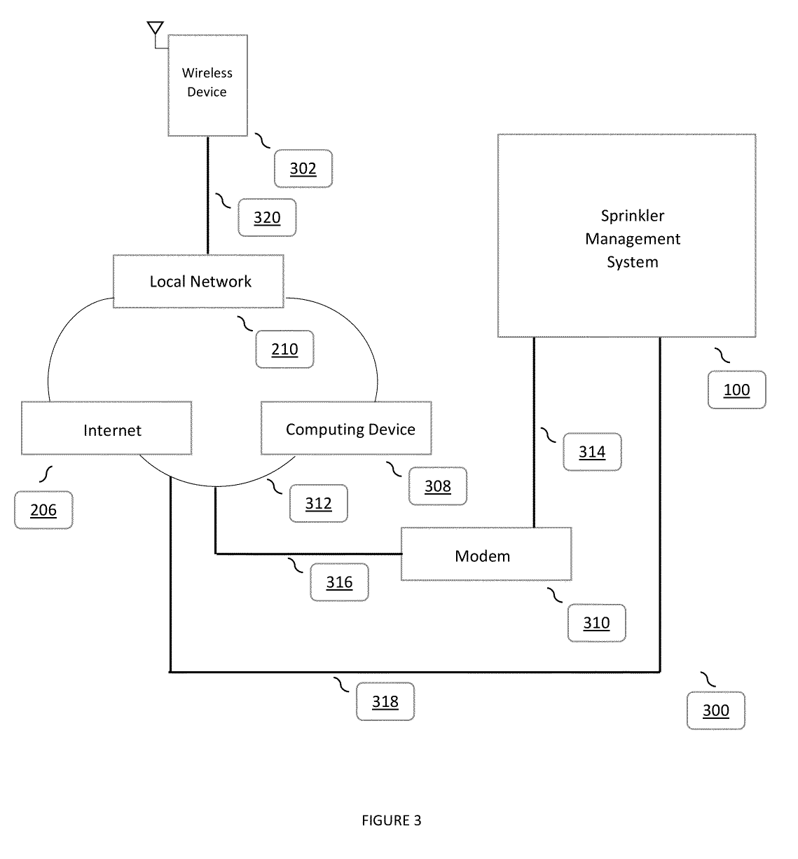

FIG. 3 is a block diagram illustrating an exemplary communications network 300 for remotely controlling sprinkler management system 100 in accordance with certain embodiments. Remote controlled sprinkler management system 100 includes a wireless device 302, local network 210, the Internet 206, computing device 308, modem 310 and sprinkler management system 100. Nodes 100, 206, 210 and 302-310 are interconnected via communications network 300, and each node 100, 206, 210 and 302-310 can include one or more processes.

Additionally, the nodes are coupled over a number of differing connections. Wireless device 302 is coupled over a digital wireless connection to network 312, including any of its individual components. Network 312, itself, comprises a combination of digital wireless and/or wireline connections, coupling local network 210, Internet 206 and computing device 308. Sprinkler management system 100 is coupled to modem 310 over an analog wired and/or wireline connection 314, which is in turn coupled over a digital wireline and/or wireless connection 316 to network 312, including any of its individual components. Sprinkler management system 100 is also coupled over a digital wired and/or wireline connection 318 to network 312, including any of its individual components.

With respect to the nodes, a single process can be run by multiple processors, or multiple processes can be run by a single processor. Additionally, each of nodes 100, 206, 210 and 302-310 can provide an interface point between network 100 and other nodes in the outside world, and can also incorporate a collection of sub-networks.

In certain exemplary embodiments, wireless device 302 can include any entities capable of performing wireless processing and communication functions. Examples of a wireless device 302 include any handheld wireless computing devices with processing capability such as cellphones, mobile web device (smartphones, tablets) and personal digital assistants.

In certain exemplary embodiments, wireless device 302 and/or computing device 308 are device that can be programmed to carry out a set or multiple sets of operations, be it arithmetic, logical, or any other form of operation, and can include a computing device with processing elements, some forms of memory and peripheral portions that allow information to be transmitted to/from external sources. In an exemplary embodiment, computing device 308 can be, but is not limited to, desktop computers, laptop computers, netbooks, tablet PC, personal digital assistants (PDAs), workstations, servers, mainframe, smartphones, and/or wireless devices 302.

In certain exemplary embodiments, modem 310 is a modulating device that modulates an analog carrier signal over connection 314 to encode digital information for transmission over connection 316 to network 312, and demodulate signals in the reverse path. Digital signals which do not need to be modulated/demodulated can be transmitted over connection 318 between sprinkler management system 100 and network 312.

In an exemplary embodiment, Internet 206 refers to a worldwide system of interconnected computer networks that use the Transmission Control Protocol/Internet Protocol (TCP/IP) set of protocols. TCP/IP, in turn, can refer to a bundle of network protocols, including: (i) the IP, a network layer protocol where unique IP addresses identify each network and each of its hosts, (ii) TCP, a connection-oriented protocol, where a connection is established via handshakes before any data is transmitted and (iii) certain application layer protocols, including telnet and file transfer protocol (FTP). Internet 206 can refer to the worldwide web, a network of computers located all over the world, which can be comprised of clients and servers that users access to locate resources.

In an exemplary embodiment that employs user interaction through communication module 114, the user can send/receive data and communicate with sprinkler management system 100 via any of the foregoing network nodes, including, for example, wireless device 302 and/or computing device 308, or a combination of the same.

In is notable that the elements comprising exemplary networks 200 and 300, depicted above, are by way of illustration only, as skilled persons will recognize that any additional network nodes, processing hardware/software, and interconnectivity of such nodes can be assembled in accordance with the present embodiments without departing from the present teachings.

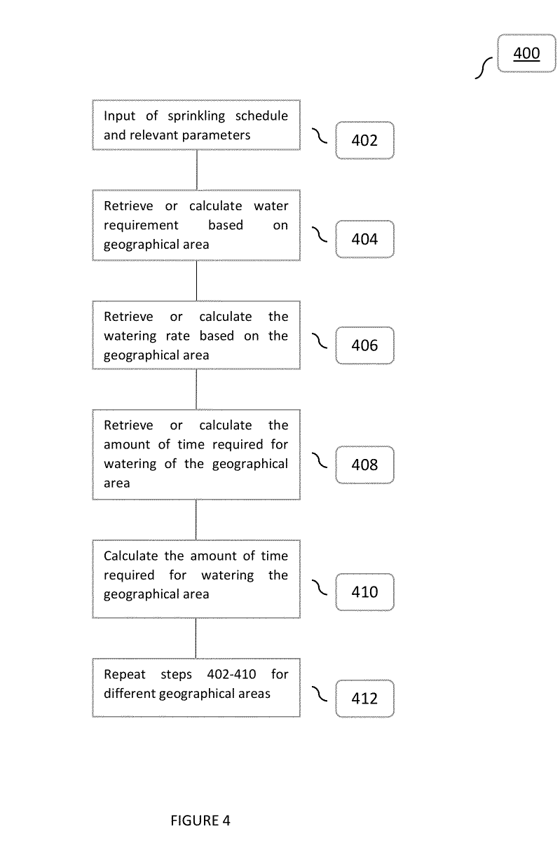

FIG. 4 is a process flow chart 400 illustrating process flows for system setup of a sprinkler management system 100 in accordance with certain embodiments. The process flow chart 400 of a sprinkler management system 100 is a process for making an operational decision to irrigate a geographical area or multiple geographical areas. Exemplary local geographical areas are referred to as zones in accord with the present embodiments.

It is noteworthy that the operational parameters, metrics and instructions used for FIGS. 4-6 hereunder can be input or output in real-time via input/output module 104 and/or communications module 114, or can have been previously recorded values, received by the same modules and recorded in memory module 102, or output to any of the devices of communications networks 200, 300 and stored on the same devices. Furthermore, environmental data, such as meteorological-related metrics, can be input by sensing module 116, and stored in one or more of the foregoing manners. The operational parameters, metrics and instructions can be input or output through interaction with and from a user. The operational parameters, metrics and instructions can also be input or output from or to memory module 102, executable programs running resident on sprinkler management module 100 (specifically in processor module 120 and/or one of its other modules) or on any of processors of any of the devices of networks 200, 300. For example, in an exemplary embodiment, inputs are retrieved from a weather programming module, such as Weather Underground (http://www.wunderground.com), accessed over an Internet 202 connection via communications path 202.

In step 402, the sprinkling schedule and relevant parameters are input. As noted, the input can be conducted by a user in real-time or have been previously input by the user, via input/output module 104 or communications module 114. The input can also be input from an executable program running resident on sprinkler management module 100 or another device in communications networks 200, 300.

In an exemplary embodiment, processor module 120 has been programmed with a repetitive period and an elongated period that includes multiple repetitive periods. In the present example, the repetitive period is set to one 24-hour day cycle, and the elongated period is set to a 7-day week.

Processor module 120, upon execution of instructions in memory module 102, runs through a setup program which requests and inputs a normal sprinkling schedule. The metrics solicited from either the user or an executing program includes any of the following: (i) the number of repetitive periods per elongated period; (ii) the number of elongated periods in consideration; (iii) the amount of time that sprinklers are to be run; (iv) the number of sprinklers that are to be run per geographical area, such as zones; (v) the number of geographical areas, such as zones, for which the sprinklers are to be run; (vi) the amount of water dispersed from a sprinkler per given duration of time; and (vii) the amount of water dispersed from all sprinklers feeding a given geographical area per given duration of time. Furthermore, one or more of the above metrics can be derived from more basic information provided by the user or the program being executed.

As a simple example, the user is solicited for and inputs that watering is to be performed on Mondays and Thursdays for a duration of 20 minutes on each of these days for an identified zone.

In step 404, the water requirement is input or calculated for one or more of the geographical areas. The total amount of water can vary based on the type of geography and the geographical size of the area. In an exemplary embodiment, the water requirement is either directly retrieved from a weather programming module, as described, or calculated based on input from the weather programming module. The water requirement can also be calculated from one or more of the above metrics. As alluded to, the water requirement can also be input by a user, or another program that is executing resident or remote from sprinkler management module 100.

In step 406, the watering rate for the geographical area is retrieved or calculated. As noted, the geographical area can be a zone, as noted, or a larger geographical area. In an exemplary embodiment, the water requirement is either directly retrieved from a weather programming module, as described, or calculated based on input from the weather programming module. In an exemplary embodiment, the water requirement is calculated from one or more of the above metrics. The water requirement can also be input by a user, or another program that is executing resident or remote from sprinkler management module 100.

In step 408, the amount of time that watering is required for a geographical area is retrieved or calculated. Certain relationships permit the calculation if not directly input. For example, when the amount of water released by each sprinkler feeding a zone per duration of time is multiplied by the amount of time the sprinkler is to be run, this provides the amount of water released per sprinkler. Furthermore, when this amount is summed for the total number of sprinklers feeding a zone, the total amount of water for the zone is obtained. The watering time can be input by a user, or calculated by another program that is executing resident or remote from sprinkler management module 100.

In certain embodiments, sprinkler management module 100, or a series of such management modules functionally and interactively coupled together, are tasked with the sprinkler management for multiple geographical areas. Here, each of the geographical areas can be independently configured. Accordingly, in step 412, steps 402-410 can be repeated for each of these geographical areas.

With respect to the foregoing steps, one or more of the parameters can be preset in lieu of or in addition to being input or calculated. For example, in an exemplary embodiment, a default rate for the watering rate is set, and in a particular such embodiment, if the watering rate cannot be calculated for a zone, the watering rate for the zone is preset to 1.28 inches of water per hour of sprinkling.

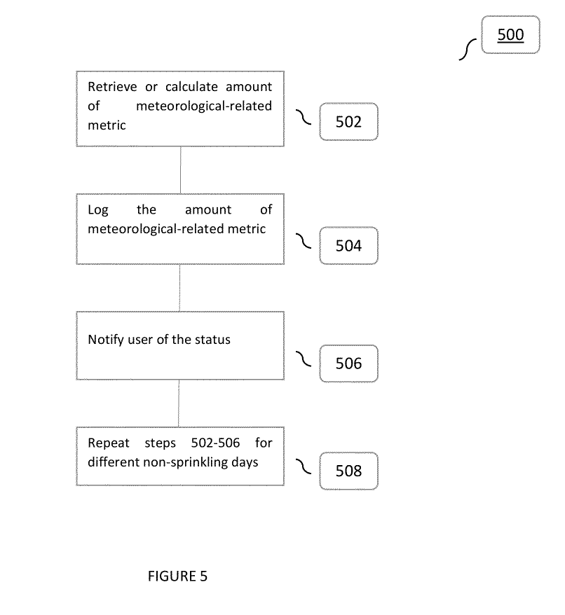

FIG. 5 is a process flow chart 500 illustrating process flows for running of sprinkler management system 100 on a repetitive period where no sprinkling occurs.

In exemplary embodiments, the first repetitive period executed sequentially follows the repetitive period in which setup of sprinkler management system 100 is conducted pursuant to process flow chart 400. As one example, the repetitive period is set to a day, the elongated period of multiple repetitive periods is set to a single week, where the setup is performed on a Saturday. Here, the sprinkler management system 100 is first run on the following Sunday.

In step 502, the amount of a meteorological-related metric is retrieved or calculated. The meteorological-related metric can be any metric associated with a meteorological-related event. Exemplary meteorological-related metrics include any one of or combinations of the following in relation to past, present or predicted for future repetitive periods (for example, a day), a single elongated period (for example, a week) and/or multiple elongated periods (for example, a year): rainfall; temperatures; temperatures during rainfall; wind speeds; sunshine or cloudiness; and ultraviolet (UV) indices. In an exemplary embodiment, these metrics are directly retrieved from a weather programming module, as described, or calculated based on input from the weather programming module. The metrics can also be input by a user, or another program that is executing resident or remote from sprinkler management module 100. The metrics can also be calculated from one or more input metrics.

The meteorological-related metrics can be input in real-time via input/output module 104 and/or communications module 114, can have been previously recorded values, received by the same modules and recorded in memory module 102, and can also be output to any of the devices of communications networks 200, 300 and stored on the devices of these networks. The meteorological-related metrics or base data leading to such metrics can also be input by sensing module 116 from the environment, processed by processor module 120 and stored in one or more of the foregoing manners. The metrics can also be input or output from or to executable programs running resident on sprinkler management module 100 (specifically in processor module 120 and/or one of its other modules) or on any of processors of any of the devices of networks 200, 300.

In step 504, the amount of the meteorological-related metric is logged. The logging can be performed resident on the sprinkler management module 100, where processor module 120 stores the data via memory module 102, or at one of the devices of networks 200, 300 in an analogous manner.

In step 506, the user can be notified of the status of the sprinkler management system 100. In one embodiment, the processor writes the status to local display 118 for view by the user. In another embodiment, input/output module 106 and/or communications module 114 are used to transmit the data to an output device functionally and interactively coupled to sprinkler management system 100. In yet another embodiment, input/output module 106 and/or communications module 114 are used to transmit the data to any output device functionally and interactively coupled to one of the devices of networks 200, 300.

In step 508, steps 502-506 are repeated in each of the repetitive periods where sprinkling is not performed. In the above noted example, where the repetitive period comprises a week, and the elongated period comprises a week, since Monday and Thursday are the only sprinkling days, where sprinkling may be performed, steps 502-506 are repeated on every other day of the week.

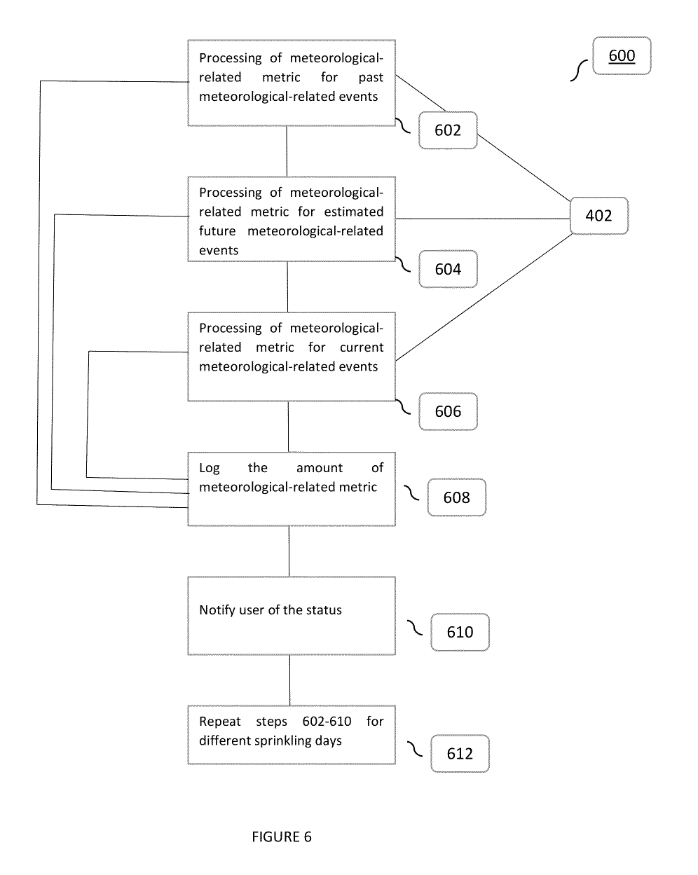

FIG. 6 is a process flow chart 600 illustrating process flows for running of sprinkler management system 100 on a repetitive period where sprinkling may occur. In these repetitive periods associated with flow chart 600, sprinkling may occur based on the steps associated with the process.

In step 602, processing is performed for past meteorological-related metrics. In exemplary embodiments, the meteorological-related metrics, and the methodologies and corresponding structures performing the methodologies, are the same as above described in relation to step 502. Here, however, the metrics being input and calculated pertain to past events. In addition, the meteorological-related metrics are not necessarily limited to a single repetitive period, but can be a processed metric, such as a summation of a metric for one or more elongated periods.

In addition, in one embodiment the meteorological-related metric or processed metric is retrieved for a geographical area, and compared to the amount of water required for the geographical area, as input and/or calculated in relation to steps 402-410. If the meteorological-related metric or processed metric is greater than a predetermined threshold, the amounts are logged in step 608, and the user is notified of the condition in step 610, with no watering being performed. On the other hand, if the foregoing amounts are not greater than the threshold, watering is performed as set forth in steps 402-412, and discontinued if either the pre-set amount of watering time for the repetitive period is achieved for the geographical area, or the total amount of watering for the elongated period is achieved for the geographical area. Here, watering is caused to be performed by processor module 120 engaging sprinkler power module 112 to cause one or more sprinkler systems to become engaged.

In relation to the foregoing example, which is not to be taken by way of limitation, watering is to be performed on Monday and Thursday, for 20 minutes per such day. The meteorological-related metric being measured is rainfall. The measurement is being performed on either Monday or Thursday, where sprinkling may be performed. The volumetric amount of rainfall pertaining to an elongated period equaling the past week is retrieved and summed for the zone. The sum is continuously compared to the total amount of watering that will take place in the zone when the sprinklers are run for 20 minutes on each of Monday and Thursday. If the sum exceeds the total amount of watering on either of these days, execution is halted, the usage is logged the same as in step 608 and the user is notified the same as in step 610. On the other hand, if the sum is not exceeded, watering is performed pursuant to steps 402-410, and these steps are repeated for different zones in step 412.

In step 604, processing is performed for estimated future meteorological-related metrics. In exemplary embodiments, these meteorological-related metrics, and the methodologies and corresponding structures performing the methodologies, are the same as above described in relation to step 502. Here, however, the metrics being input and calculated pertain to future estimation, such as the chance of a meteorological-related event, and are not necessarily limited to a single repetitive period.

In addition, in one embodiment the estimated future meteorological-related metric, or processed metric as the case may be, is retrieved for a geographical area, and compared to the amount of water required for the geographical area, as input and/or calculated in relation to steps 402-410. If the estimated future meteorological-related metric is greater than a predetermined threshold, the amounts are logged in step 608, and the user is notified of the condition in step 610, with no watering being performed. On the other hand, if the foregoing amounts are not greater than the threshold, watering is performed as set forth in steps 402-412, and discontinued if either the pre-set amount of watering time for the repetitive period is achieved for the geographical area, or the total amount of watering for the elongated period is achieved for the geographical area.

In relation to the foregoing example, which is not to be taken by way of limitation, as noted watering is to be performed on Monday and Thursday, for 20 minutes per such day. The estimated future meteorological-related metric is a 80% chance of rainfall for the day. The measurement is being performed on either Monday or Thursday, where sprinkling may be performed. The threshold amount pre-set by the user is 70%. Because the 80% amount is greater than the 70% threshold amount, the decision is made to halt watering for the day. Here, the amounts are logged in step 608, and the user is notified of the condition in step 610. On the other hand, had the threshold amount not been exceeded, watering would have been performed pursuant to steps 402-410, and these steps would have been repeated for different zones in step 412.

In step 606, processing is performed for current meteorological-related metrics in relation to an estimated future meteorological-related metrics. In exemplary embodiments, these meteorological-related metrics, and the methodologies and corresponding structures performing the methodologies, are the same as above described in relation to step 502. Here, however, the metrics being input and calculated pertain to current status and estimated future status, such as the existence of a current meteorological-related metric and the amount of a current meteorological-related event, and are not necessarily limited to a single repetitive period.

In addition, in one embodiment the former are retrieved for a geographical area, and compared to the amount of water required for the geographical area, as input and/or calculated in relation to steps 402-410. If the current meteorological-related metric is the existence of a condition, and the estimated future meteorological-related metric is greater than a predetermined threshold, the amounts are logged in step 608, and the user is notified of the condition in step 610, with no watering being performed.

In an alternative yet related exemplary embodiment, the foregoing step is repeated on an hourly basis until the threshold is surpassed before the determination is made that no watering is to take place.

If the foregoing amounts are not greater than the threshold, watering is performed as set forth in steps 402-412, and discontinued if either the pre-set amount of watering time for the repetitive period is achieved for the geographical area, or the total amount of watering for the elongated period is achieved for the geographical area.

In relation to the foregoing example, which is not to be taken by way of limitation, as noted watering is to be performed on Monday and Thursday, for 20 minutes per such day. The current meteorological-related metric is the fact that the weather is currently rainy. The measurement is being performed on either Monday or Thursday, where sprinkling may be performed. The threshold amount pre-set by the user is 70%. While the rain condition exists, on an hourly basis the chance of rain for the day is determined, and when the chance of rain surpasses the threshold amount, the decision is made to halt watering for the day. Here, the amounts are logged in step 608, and the user is notified of the condition in step 610. On the other hand, had the threshold amount not been exceeded while it was raining, watering would have been performed pursuant to steps 402-410, and these steps would have been repeated for different zones in step 412.

In step 608, the amount of the meteorological-related metric is logged. Here, the methodologies, and corresponding structures implementing the methodologies, of step 504 are followed, in relation to the particular meteorological-related metrics and processed information pertaining to any one of steps 602-606.

In step 610, the user can be notified of the status of the sprinkler management system 100. Here, the methodologies, and corresponding structures implementing the methodologies, of step 506 are followed, in relation to the particular meteorological-related metrics and processed information pertaining to any one of steps 602-606.

In step 612, steps 602-610 are repeated in each of the repetitive periods where sprinkling may be performed. In the above noted example, where the repetitive period comprises a week, and the elongated period comprises a week, since Monday and Thursday are the only possible sprinkling days, steps 602-610 are repeated on these days solely.

Machine Instructions Environment

In one or more embodiments, the steps of the present invention are embodied in machine-executable instructions. The instructions can be used to cause a processing device, for example a general-purpose or special purpose processor, which is programmed with the instructions, to perform the steps of the present invention.

For example, the present invention can be provided as a computer program product. In this environment, the invention can include a machine-readable medium having instructions stored on it. The instructions can be used to program any processor (or other electronic devices) to perform a process according to the present invention.

In addition, the present invention can also be downloaded as a computer program product. Here, the program can be transferred from a remote computer (e.g., a server) to a requesting computer (e.g., a client) by way of data signals embodied in a carrier wave or other propagation medium via a communication link (e.g., a modem or network connection).

The present invention can be implemented using computer programs (i.e., “software,” or “computer control logic”) running on Processor 204. The software can be originally stored as a “computer program product” on removable storage device 218 or hard disk drive 212. Therefore, computer program product refers to means for providing software to computer system 200.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant arts.

Certain Explanatory Conclusions

As referenced hereinabove, “exemplary embodiment(s),” “one embodiment,” “an embodiment,” or similar language means that a particular feature, structure, or characteristic described in connection with the embodiment is included in at least one embodiment described in the specification. Accordingly, appearances of the phrases “exemplary embodiment(s),” “in one embodiment,” “in an embodiment,” and similar language throughout this specification may, but do not necessarily, all refer to the same embodiment.

Additionally, the described features, structures, or characteristics of the described embodiments may be combined in any suitable manner in one or more embodiments. In the foregoing description, numerous specific details are provided, such as examples of hardware, software, programming, networking, databases, modules, user interfaces, among many others, to provide a complete understanding of the embodiments. Persons skilled in the relevant art(s) will recognize, however, that these embodiments may be practiced without one or more of the specific details, or with other methods, components, materials, and the like. In certain instances, well known structures, materials, or operations are not described or illustrated in detail to avoid obscuring certain aspects of the embodiments and in view of one skilled in the relevant art(s).

Certain schematic flow chart diagrams are included herein, and are generally set forth as logical flow chart diagrams. It should be noted that as such, the depicted order and labeled operations herein are indicative of one or more exemplary embodiments of certain presented methods. Other operations and methods can be conceived by skilled persons that are equivalent in function, logic, or effect to one or more operations, or portions thereof, of the illustrated methods. Also, the format and symbols used are provided to explain the logical operations of these methods and are not to limit the scope of the methods. Although various connectors, lines and arrow types can be employed in the flow chart diagrams, they are not to limit the scope of the corresponding methods. Indeed, some of such connectors can be used to indicate only the logical flow of these methods. Additionally, the order in which a particular method occurs may or may not strictly adhere to the order of the corresponding operations shown.

Although the operations of the methods herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Lastly, while various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for automated sprinkle management for managing a sprinkler system in a plurality of repetitive periods, comprising:
(a) for a said present repetitive period wherein sprinkling is not to be performed, retrieving an amount of one or more meteorological-related metrics for a previous repetitive period, and logging said amount;
(b) for a said present repetitive period wherein sprinkling is to be performed,
(A) retrieving for an elongated period comprising a multiple of said repetitive periods one or more of said amounts and calculating a sum of said one or more of said amounts for said elongated period; and
(B) determining a sprinkling interval based at least in part on said sum, said sprinkling interval comprising a period of time wherein the sprinkler system is operable; and
(c) causing the sprinkler system to operate for said sprinkling interval if sprinkling is to be performed.

2. A method according to claim 1, wherein step (b) further comprises:
(C) comparing a first pre-established threshold value to a said meteorological-related metric to determine a first comparison value; and
(D) determining said sprinkling interval based at least in part on said first comparison value.

3. A method according to claim 2, wherein step (b) further comprises:
(E) if a said meteorological-related event is present, one or more times: retrieving a chance of continuation of said meteorological-related event within a designated time period, and comparing said chance of continuation to a second pre-established threshold value to determine a second comparison value; and
(F) determining said sprinkling interval based at least in part on said second comparison value.

3. A method according to claim 1, wherein any one of steps (a) and (b) are performed for at least one geographical area.

4. A method according to claim 2, wherein each of steps (a) and (b) is performed in sequential order, and wherein the at least one geographical area comprises a zone.

5. A method according to claim 1, further comprising any one of:
(d) receiving a first sprinkling input, the first sprinkling input relating to at least one of: a frequency of sprinkling; and a period of sprinkling, and receiving a second sprinkling input, the second sprinkling input relating to an amount of sprinkling, wherein the determining of said sprinkling interval is based on the first sprinkling input and the second sprinkling input; and
(e) determining said sprinkling interval by retrieving a predetermined default value and assigning said value as said sprinkling interval.

6. A method according to claim 5, wherein said first sprinkling input is retrieved from any one of: a user over a human-user interface; and a system over a communications interface.

7. A method according to claim 5, wherein said frequency of sprinkling comprises an identify of one or more days wherein sprinkling is performed per week, and wherein said period of sprinkling comprises a period of time wherein sprinkling is performed per each said sprinkling day.

8. A method according to claim 5, wherein the amount of sprinkling comprises any one of: a volumetric related amount of sprinkling performed by the sprinkler system, the sprinkler system being managed by an automated sprinkle management system; and a predetermined default volumetric related amount of sprinkling.

9. A method according to claim 1, wherein one or more indications are displayed to a user in relation to any one of said steps (a) and (b); and wherein the displaying is effected in relation to at least one of: a local display resident on an automated sprinkle management system; and a remote display remote to said automated sprinkle management system.

10. A method according to claim 1, wherein at least one of: the repetitive period is a present day of a week; the previous repetitive period is a day of said week preceding said present day; the meteorological-related metric is an amount of rainfall; and the elongated period comprising a multiple of said repetitive periods is a week.

11. A method according to claim 2, wherein said meteorological-related metric of step (C) is a chance of rain, and the first pre-established threshold value is a threshold value relating to said chance of rain.

12. A method according to claim 3, wherein any one of: said meteorological-related metric of step (C) and said meteorological-related metric of step (E) is a chance of rain; and wherein any one of: said first pre-established threshold value is a threshold value relating to said chance of rain; and said second pre-established threshold value is a threshold value relating to said chance of rain.

13. An automated sprinkle management system for managing a sprinkler system in a plurality of repetitive periods, the system comprising:
a memory operable to retain a series of instructions; and
a processor operable to retrieve and execute said instructions to perform a series of steps, the steps comprising:
(a) retrieving an amount of one or more meteorological-related metrics for a previous repetitive period, and logging said amount, if sprinkling is not to be performed for a said present repetitive period; and
(b) for a said present repetitive period wherein sprinkling is to be performed, (A) retrieving for an elongated period comprising a multiple of said repetitive periods one or more of said amounts and calculating a sum of said one or more of said amounts for said elongated period; and (B) determining a sprinkling interval based at least in part on said sum, said sprinkling interval comprising a period of time wherein the sprinkler system is operable; and
a power module operable to (c) cause the sprinkler system to operate for said sprinkling interval if sprinkling is to be performed.

14. A system according to claim 13, wherein step (b) further comprises: (C) comparing a first pre-established threshold value to a said meteorological-related metric to determine a first comparison value; and (D) determining said sprinkling interval based at least in part on said first comparison value.

15. A system according to claim 14, wherein step (b) further comprises: (E) if a said meteorological-related event is present, one or more times: retrieving a chance of continuation of said meteorological-related event within a designated time period, and comparing said chance of continuation to a second pre-established threshold value to determine a second comparison value; and (F) determining said sprinkling interval based at least in part on said second comparison value.

16. A system according to claim 13, wherein any one of steps (a) and (b) are performed for at least one geographical area.

17. A system according to claim 14, wherein each of steps (a) and (b) is performed in sequential order, and wherein the at least one geographical area comprises a zone.

18. A system according to claim 13, the steps further comprising any one of: (c) receiving a first sprinkling input, the first sprinkling input relating to at least one of: a frequency of sprinkling; and a period of sprinkling, and receiving a second sprinkling input, the second sprinkling input relating to an amount of sprinkling, wherein the determining of said sprinkling interval is based on the first sprinkling input and the second sprinkling input; and (d) determining said sprinkling interval by retrieving a predetermined default value and assigning said value as said sprinkling interval.

19. A system according to claim 18, wherein said first sprinkling input is retrieved from any one of: a user over a human-user interface; and a system over a communications interface.

20. A system according to claim 18, wherein said frequency of sprinkling comprises an identify of one or more days wherein sprinkling is performed per week, and wherein said period of sprinkling comprises a period of time wherein sprinkling is performed per each said sprinkling day.

21. A system according to claim 18, wherein the amount of sprinkling comprises any one of: a volumetric related amount of sprinkling performed by the sprinkler system, the sprinkler system being managed by the automated sprinkle management system; and a predetermined default volumetric related amount of sprinkling.

22. A system according to claim 13, wherein one or more indications are displayed to a user in relation to any one of said steps (a) and (b); and wherein the displaying is effected in relation to at least one of: a local display resident on the automated sprinkle management system; and a remote display remote to said automated sprinkle management system.

23. A system according to claim 13, wherein at least one of: the repetitive period is a present day of a week; the previous repetitive period is a day of said week preceding said present day; the meteorological-related metric is an amount of rainfall; and the elongated period comprising a multiple of said repetitive periods is a week.

24. A system according to claim 14, wherein said meteorological-related metric of step (C) is a chance of rain, and the first pre-established threshold value is a threshold value relating to said chance of rain.

25. A system according to claim 15, wherein any one of: said meteorological-related metric of step (C) and said meteorological-related metric of step (E) is a chance of rain; and wherein any one of: said first pre-established threshold value is a threshold value relating to said chance of rain; and said second pre-established threshold value is a threshold value relating to said chance of rain.
